(19) United States
(12) Patent Application Publication
(10) Pub. No.: US 2016/0099493 A1
(43) Pub. Date: Apr. 7, 2016

(54) Antenna Device

(71) Applicants: Richard Smith, Dallas, TX (US); Byron Hasty, Flower Mound, TX (US)

(72) Inventors: Richard Smith, Dallas, TX (US); Byron Hasty, Flower Mound, TX (US)

(21) Appl. No.: 14/505,265

(22) Filed: Oct. 2, 2014

(51) Int. Cl. H01Q 1/12

(52) U.S. Cl. CPC H01Q 1/1207; H01Q 1/1235

(57) ABSTRACT

An antenna device to send and receive radio waves includes a base plate having a first curved slot and a first antenna wall having a first locking arm. The first locking arm a be planar in a first position and deformed to extend through the curved slot in a second position and returns to the first position after passing through the curved slot.

### FIELD OF THE INVENTION

The present invention relates to an antenna device and more particularly to a apparatus for mounting antenna walls on a base plate.

### BACKGROUND

An antenna is an electrical device which converts electric power into radio waves, and vice versa. It is usually used with a radio transmitter or radio receiver. In transmission, a radio transmitter supplies an electric current oscillating at radio frequency (i.e. high frequency AC) to the antenna's terminals, and the antenna radiates the energy from the current as electromagnetic waves (radio waves). In reception, an antenna intercepts some of the power of an electromagnetic wave in order to produce a tiny voltage at its terminals, that is applied to a receiver to be amplified.

Antennas are essential components of all equipment that uses radio. They are used in systems such as radio broadcasting, broadcast television, two-way radio, communications receivers, radar, cell phones, and satellite communications, as well as other devices such as garage door openers, wireless microphones, bluetooth enabled devices, wireless computer networks, baby monitors, and RFID tags on merchandise.

Typically, an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna.

Antennas may also include reflective or directive elements or surfaces not connected to the transmitter or receiver, such as parasitic elements, parabolic reflectors or horns, which serve to direct the radio waves into a beam or other desired radiation pattern. Antennas can be designed to transmit or receive radio waves in all directions equally (omnidirectional antennas), or transmit them in a beam in a particular direction, and receive from that one direction only (directional or high gain antennas).

### SUMMARY

An antenna device to send and receive radio waves includes a base plate having a first curved slot and a first antenna wall having a first locking arm.

The first locking arm a be planar in a first position and deformed to extend through the curved slot in a second position and returns to the first position after passing through the curved slot.

The first antenna wall may include a second locking arm. The second locking arm may be planar in a first position and deformed to extend through a second curved slot in a second position and returns to the first position after passing through the curved slot.

The antenna device may include a second antenna wall including a third locking arm. The third locking arm may be planar in a first position and deformed to extend through a third curved slot in a second position and returns to the first position after passing through the third curved slot.

The second antenna wall may include a fourth locking arm. The fourth locking arm may be planar in a first position and deformed to extend through a fourth curved slot in a second position and returns to the first position after passing through the fourth curve slot.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the base plate of the antenna device of the present invention;

FIG. 2 illustrates a bottom view of the base plate of the antenna device of the present invention;

FIG. 3 illustrates a front view of the first antenna wall of the antenna device of the present invention;

FIG. 4 illustrates a front view of the second antenna wall of the antenna device of the present invention;

FIG. 5 illustrates a bottom view of the base plate being connected to the first and second antenna walls of the present invention.

FIG. 6 illustrates a perspective view of the antenna device of the present invention;

FIG. 7 illustrates a back view of the first antenna wall of the present invention;

FIG. 8 illustrates a top view of the first antenna wall of the present invention;

FIG. 9 illustrates a back view of the second antenna wall of the present invention;

FIG. 10 illustrates a top view of the second antenna wall of the present invention;

FIG. 11 illustrates an exploded assembly order in a first position of the present invention;

FIG. 12 illustrates an exploded assembly order in a second position of the present invention;

FIG. 13 illustrates an exploded assembly order in a third position of the present invention;

FIG. 14 illustrates the first antenna wall prior to the installation of the present invention;

FIG. 15 illustrates the alignment tabs being engaged with the base plate of the present invention;

FIG. 16 illustrates the first antenna wall being installed on the base plate of the present invention;

FIG. 17 illustrates a top view of the first antenna wall, the second antenna wall and the base plate of the present invention;

FIG. 18 illustrates a cross-sectional view of the base plate and first antenna wall of the present invention.

### DETAILED DESCRIPTION

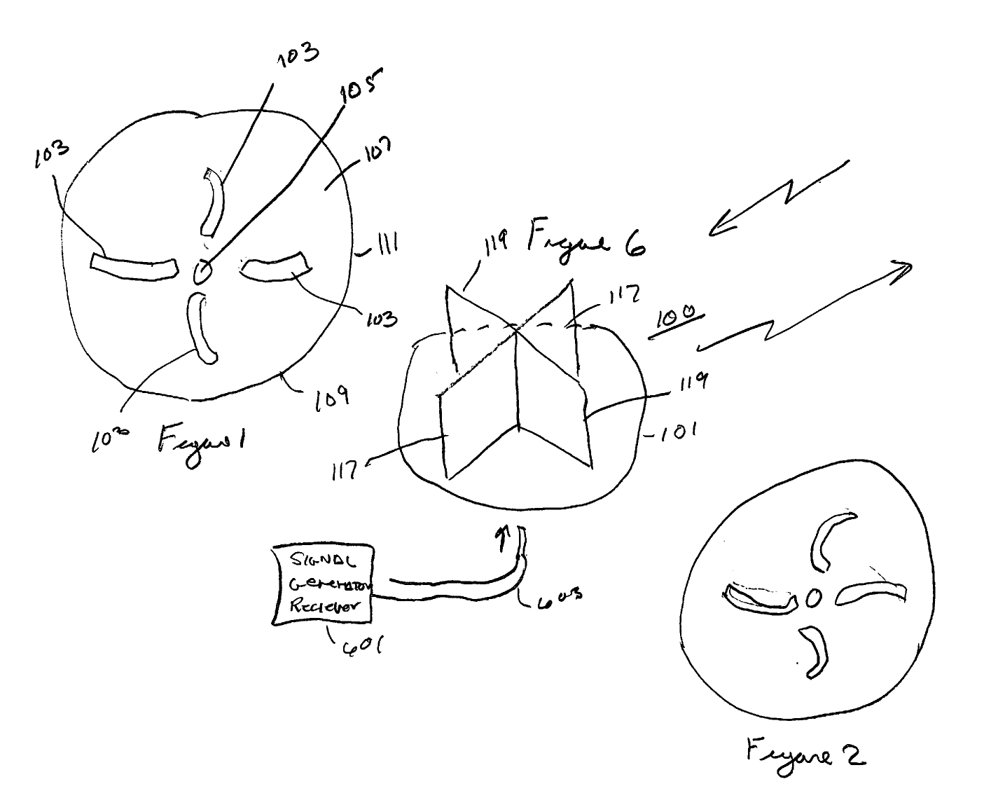

FIG. 1 illustrates the base plate 101 of the antenna device 100 which may include a top surface 107, a bottom surface 109 which may be opposed to the top surface 107 and a peripheral side surface 111 which may connect to the top surface 107 and to the bottom surface 109. The antenna device 100 may send and receive radio signals. FIG. 1 additionally illustrates that the base plate 101 includes retaining slots 103 which may extend completely through the base plate 101 to cooperate with a first locking arm 113 and a second locking arm 115. The retaining slots 103 may be curved, concave and/or crescent shaped.

The first locking arm 113 and the second locking arm 115 may be substantially planar in a first position and may be flexible in order to be deformed to correspond approximately to the retaining slots 103 which may be curved or crescent shaped to allow the first locking arm 113 and the second locking arm 115 to extend through the retaining slots 103. The first locking arm 113 and the second locking arm 115 may include alignment tabs 114 which may extend downward from the first locking arm 113 and the second locking arm 115 to align the first locking arm 113 and the second locking arm 115 with the retaining slots 103. The first locking arm 113 and the second locking arm 115 may return to the first position after the first locking arm 113 and the second locking arm 115 have passed through the retaining slots 103. The first locking arm 113 and the second locking arm 115 may be flexible and or deformable in order that the first locking arm 113 and the second locking arm 115 may be deformed to the place through the retaining slots 103 in a first position and return to a non-deformed state in order to cooperate with the base plate 101 in a second position to maintain the first antenna wall 117 and the second antenna wall 119 in a substantially perpendicular position with respect to the base plate 101.

FIG. 1 additionally illustrates a center aperture 105 which extends through the base plate 101 in order to allow wires and other electronics to be connected to the first antenna wall 117 and the second antenna wall 119.

FIG. 2 illustrates a bottom view of the base plate 101 of the antenna device 100 which may include a a top surface 107, a bottom surface 109 which may be opposed to the top surface 107 and a peripheral side surface 111 which may connect to the top surface 107 and to the bottom surface 109.

FIG. 2 additionally illustrates that the base plate 101 includes retaining slots 103 which may extend completely through the base plate 101 to cooperate with a first locking arm 113 and a second locking arm 115. The retaining slots 103 may be curved, concave and/or crescent shaped.

The first locking arm 113 and the second locking arm 115 may be flexible and or deformable in order that the first locking arm 113 and the second locking arm 115 may be deformed to the place through the retaining slots 103 in a first position and return to a non-deformed state in order to cooperate with the base plate 101 in a second position to maintain the first antenna wall 117 and the second antenna wall 119 in a substantially perpendicular position with respect to the base plate 101.

FIG. 2 additionally illustrates a center aperture 105 which extends through the base plate 101 in order to allow wires and other electronics to be connected to the first antenna wall 117 and the second antenna wall 119.

FIG. 3 illustrates a first antenna wall 117 which may include a substantially planar front surface 121, a planar back surface 123 which may be opposed to the front surface 121, a top surface 125 which may connect the front surface 121 and the back surface 123, a side surface 127 which may connect the front surface 121 and the back surface 123 and a bottom surface 129 to connect the front surface 121 and the back surface 123.

FIG. 3 additionally illustrates that the front antenna wall 117 may include a first locking arm 113 and an opposing second locking arm 115. The first locking arm 113 and the second locking arm 115 may be substantially L-shaped and may extend from the bottom surface 129. The first locking arm 113 including the alignment tab 114 and the second locking arm 115 including the alignment tab 114 may cooperate with the retaining slots 103 in order to maintain the first antenna wall 117 substantially perpendicular to the base plate 101.

The first antenna wall 117 may include a connecting slot 128 which may extend through the first antenna wall 117 in order to cooperate with the second antenna wall 119.

The bottom surface 129 may include a center slot 127 to cooperate with the center aperture 105 of the base plate 101.

FIG. 7 illustrates a first antenna wall 117 which may include a substantially planar front surface 121, a planar back surface 123 which may be opposed to the front surface 121, a top surface 125 which may connect the front surface 121 and the back surface 123, a side surface 127 which may connect the front surface 121 and the back surface 123 and a bottom surface 129 to connect the front surface 121 and the back surface 123.

FIG. 7 additionally illustrates that the front antenna wall 117 may include a first locking arm 113 including the alignment tab 114 and an opposing second locking arm 115 including the alignment tab 114. The first locking arm 113 and the second locking arm 115 may be substantially L-shaped and may extend from the bottom surface 129. The first locking arm 113 and the second locking arm 115 may cooperate with the retaining slots 103 in order to maintain the first antenna wall 117 substantially perpendicular to the base plate 101.

The first antenna wall 117 may include a connecting slot 128 which may extend through the first antenna wall 117 in order to cooperate with the second antenna wall 119.

The bottom surface 129 may include a center slot 127 to cooperate with the center aperture 105 of the base plate 101.

FIG. 10 illustrates a top view of the first antenna wall 117 and illustrates the top surface 125, the back surface 123 and the front surface 121.

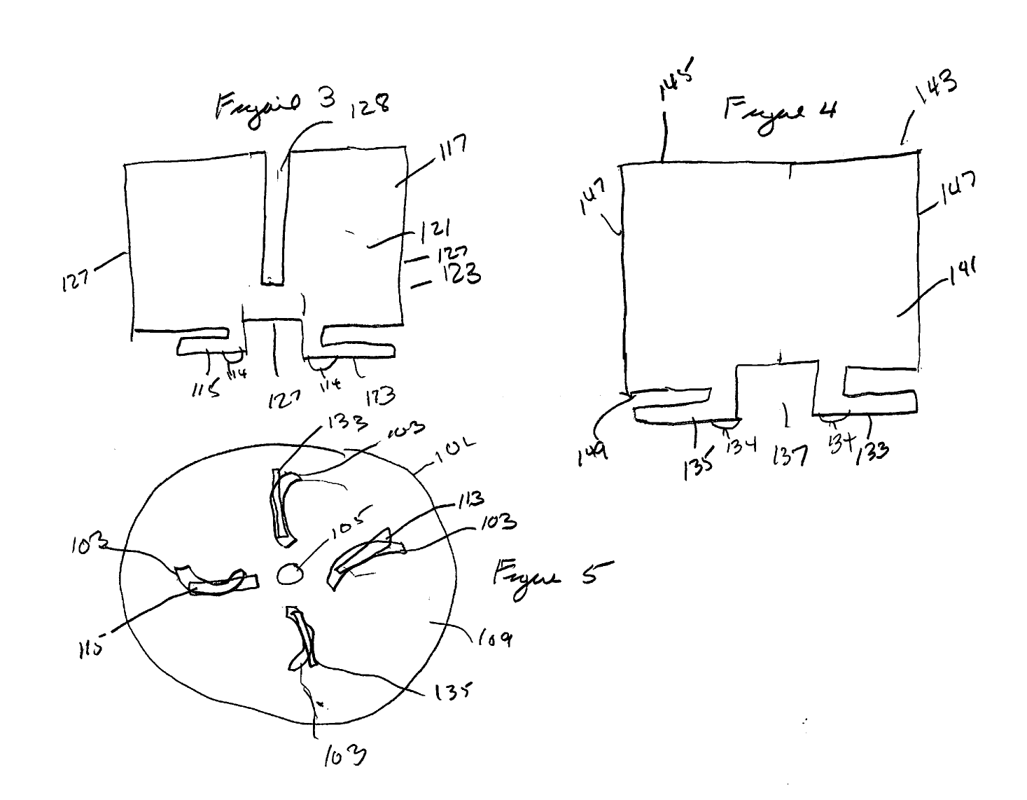

FIG. 4 illustrates a second antenna wall 119 which may include a substantially planar front surface 141, a planar back surface 143 which may be opposed to the front surface 141, a top surface 145 which may connect the front surface 141 and the back surface 143, a side surface 147 which may connect the front surface 141 and the back surface 143 and a bottom surface 149 to connect the front surface 121 and the back surface 123.

FIG. 4 additionally illustrates that the second antenna wall 119 may include a third locking arm 133 and an opposing fourth locking arm 135. The third locking arm 113 may include a second aligning tab 134 which may extend downward from the third locking arm 113 in order to align with the retaining slot 103. Additionally the fourth locking arm 135 may include the second aligning tab 134 which may extend outwards from the fourth locking arm 135 in order to align with the retaining slot 103. The third locking arm 133 and the fourth locking arm 135 may be substantially L-shaped and may extend from the bottom surface 149. The third locking arm 133 and the fourth locking arm 135 (and the second alignment tabs 134) may cooperate with the retaining slots 103 in order to maintain the second antenna wall 119 substantially perpendicular to the base plate 101.

The third locking arm 133 and the fourth locking arm 135 may be substantially planar in a first position and may be flexible in order to be deformed with the aid of the alignment tabs 134 to correspond approximately to the retaining slots 103 which may be curved or crescent shaped to allow the third locking arm 133 and the fourth locking arm 135 to extend through the retaining slots 103 with the alignment tabs 134. The third locking arm 133 and the fourth locking arm 135 may return to the first position after the third locking arm 133 and the fourth locking arm 135 have passed through the retaining slots 113.

The bottom surface 139 may include a center slot 137 to cooperate with the center aperture 105 of the base plate 101.

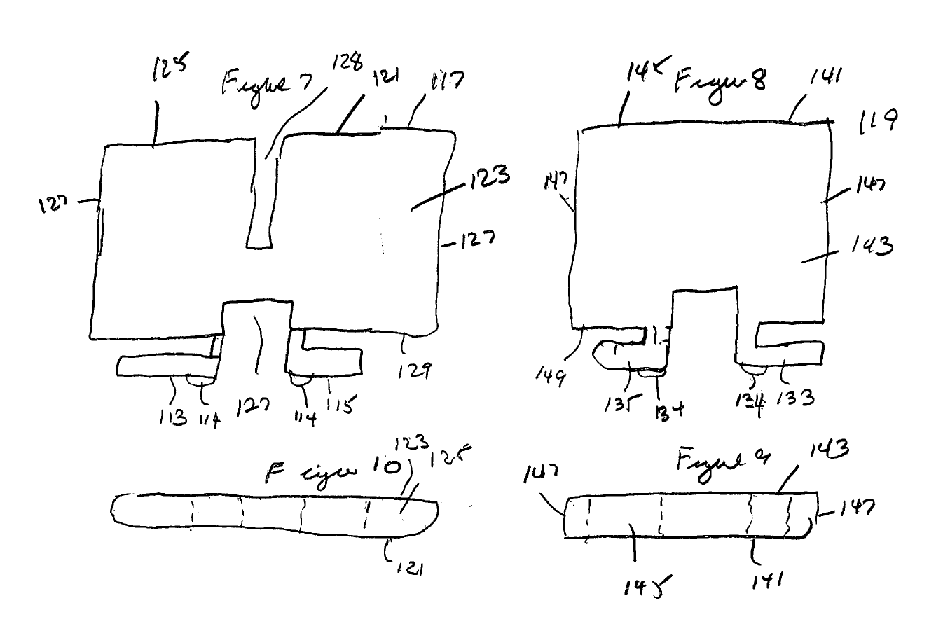

FIG. 8 illustrates a back view of the second antenna wall 119 which may include a substantially planar front surface 141, a planar back surface 143 which may be opposed to the front surface 141, a top surface 145 which may connect the front surface 141 and the back surface 143, a side surface 147 which may connect the front surface 141 and the back surface 143 and a bottom surface 149 to connect the front surface 121 and the back surface 123.

FIG. 8 additionally illustrates that the second antenna wall 119 may include a third locking arm 133 which may include the second alignment tab 134 and an opposing fourth locking arm 135 which may include the second alignment tab 134. The third locking arm 133 and the fourth locking arm 135 may be substantially L-shaped and may extend from the bottom surface 149. The third locking arm 133 and the fourth locking arm 135 may cooperate with the retaining slots 103 by the operation of the alignment tabs 134 in order to maintain the second antenna wall 119 substantially perpendicular to the base plate 101.

FIG. 9 illustrates a top view of the second antenna wall 119 and illustrates the top surface 145, the front surface 141, the back surface 143 and the side surface 147.

FIG. 6 illustrates a perspective view of the antenna device 100 of the present invention and illustrates the first antenna wall 117 substantially perpendicular to the second antenna wall 119. Both the first antenna wall 117 and the second antenna wall 119 are mounted on the base plate 101. FIG. 6 additionally illustrates a signal generator 601 which may be connected to a signal cable 603 which may connect to the antenna device 100 in order to transmit or receive wireless signals.

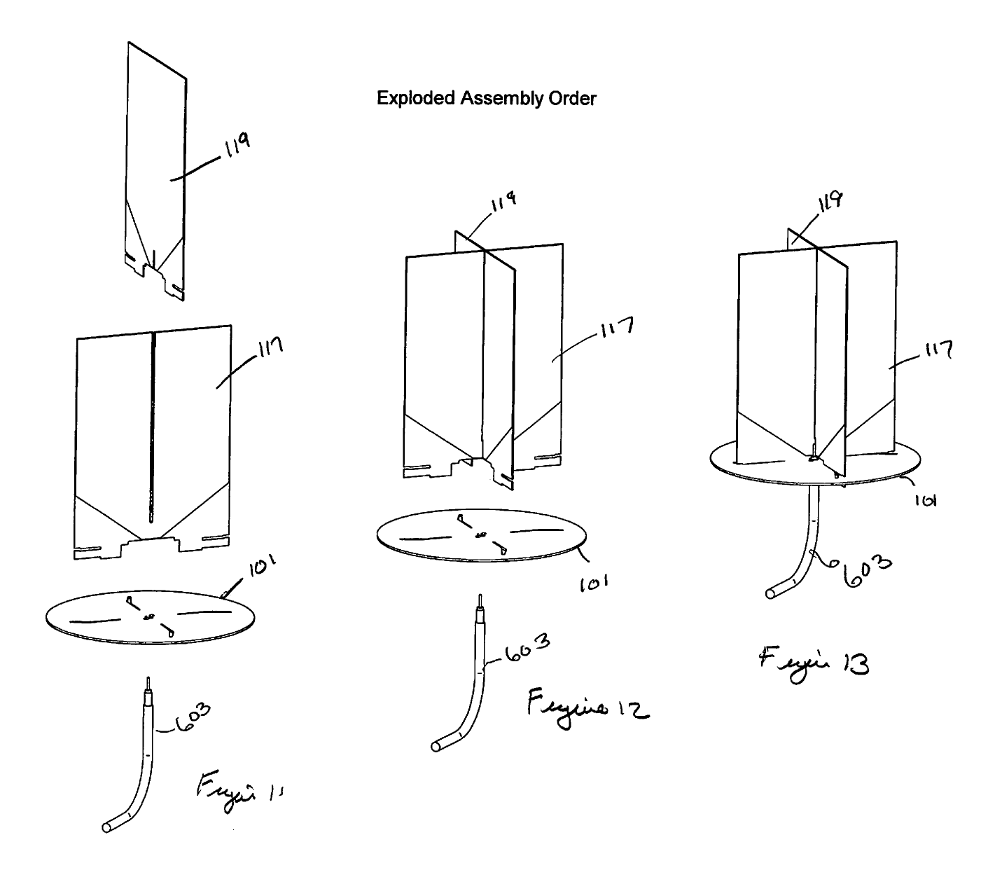

FIG. 5 illustrates a bottom view of the base plate 101 and illustrates the first locking arm 113 and the second locking arm 115 which have been distorted to be placed through the retaining slots 103 and then returned to the original position to cooperate with the bottom surface 109 of the base plate 101. Likewise, the third locking arm 133 and the fourth locking arm 135 have been distorted to the place through the retaining slots 103 and then returned to the original position to cooperate with the bottom surface 109 of the base plate 100. FIG. 11 illustrates an exploded assembly order in a first position of the present invention where the first antenna wall 117 and the second antenna wall 119 are separated from the base plate 101.

FIG. 12 illustrates an exploded assembly order in a second position of the present invention where the first antenna wall 117 is connected to the second antenna wall 119 but is not connected to the base plate 101.

FIG. 13 illustrates an exploded assembly order in a third position of the present invention where the first antenna wall 117 and the second antenna wall 119 is connected to the base plate 101.

FIG. 14 illustrates the first antenna wall prior to the installation of the present invention where the first antenna wall 117 is not connected to the base plate 101.

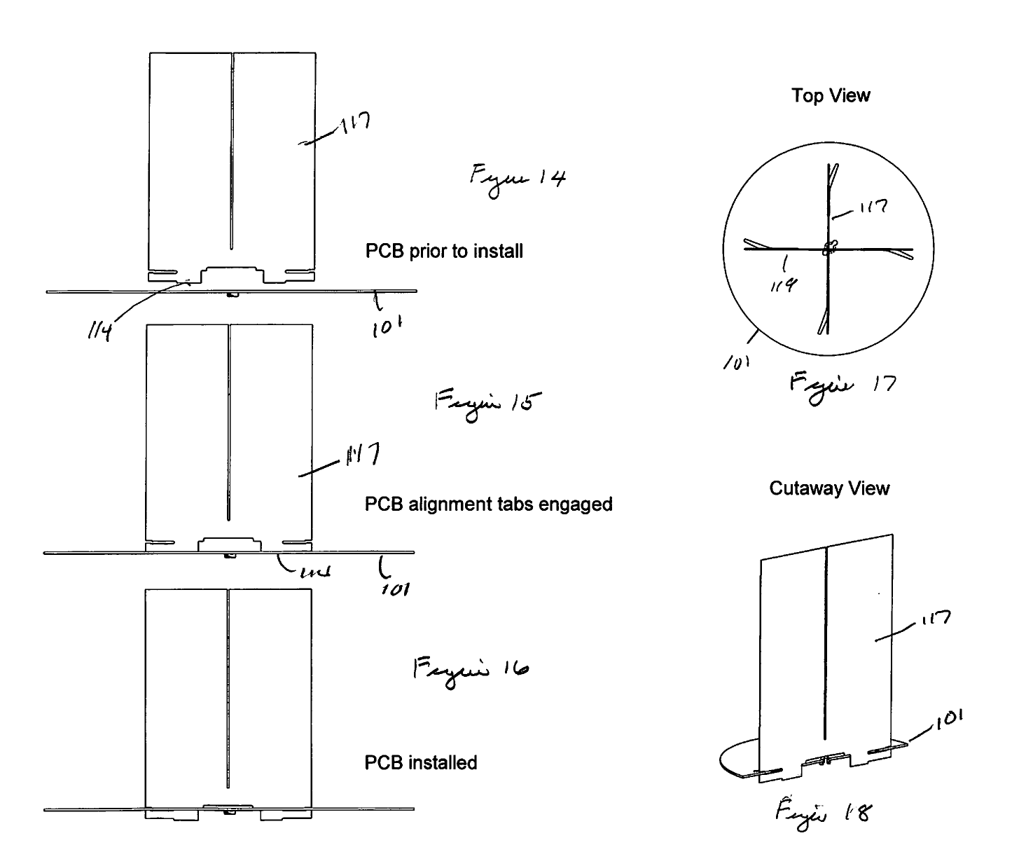

FIG. 15 illustrates the alignment tabs 114 are engaged with the base plate 101 of the present invention.

FIG. 16 illustrates the first antenna wall 117 is connected on the base plate 101 of the present invention where the first locking arms 113 engage the connecting slot 128;

FIG. 17 illustrates a top view of the first antenna wall 117, the second antenna wall 119 and the base plate 101 of the present invention;

FIG. 18 illustrates a cross-sectional view of the base plate 101 and first antenna wall 117 of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An antenna device to send and receive radio waves, comprising:
a base plate having a first curved slot;
a first antenna wall having a first locking arm;
wherein the first locking arm is planar in a first position and deformed to extend through the curved slot in a second position and returns to the first position after passing through the curved slot.

2. An antenna device to send and receive radio waves as in claim 1, wherein the first antenna wall includes a second locking arm wherein the second locking arm is planar in a first position and deformed to extend through a second curved slot in a second position and returns to the first position after passing through the curved slot.

3. An antenna device to send and receive radio waves as in claim 1, wherein the antenna device includes a second antenna wall including a third locking arm where in the third locking arm is planar in a first position and deformed to extend through a third curved slot in a second position and returns to the first position after passing through the third curved slot.

4. An antenna device to send and receive radio waves as in claim 3, wherein the second antenna wall includes a fourth locking arm wherein the fourth locking arm is planar in a first position and deformed to extend through a fourth curved slot in a second position and returns to the first position after passing through the fourth curve slot.
